(19) United States
(12) Patent Application Publication
(10) Pub. No.: US 2015/0100733 A1
(43) Pub. Date: Apr. 9, 2015

(54) Efficient Memory Organization

(71) Applicant: Synopsys, Inc., Mountain View, CA (US)

(72) Inventors: Carlos Basto, Santa Clara, CA (US); Karthik Thucanakkenpalayam Sundararajan, Santa Clara, CA (US)

(21) Appl. No.: 14/505,421

(22) Filed: Oct. 2, 2014

Related U.S. Application Data
(60) Provisional application No. 61/886,559, filed on Oct. 3, 2013.

(51) Int. Cl. G06F 12/08; G06F 12/10

(52) U.S. Cl. CPC G06F 12/0846; G06F 12/0875; G06F 12/1054; G06F 2212/452; G06F 2212/682; G06F 2212/403
USPC 711/123

(57) ABSTRACT

A computer system and method is disclosed for efficient cache memory organization. One embodiment of the disclosed system include dividing the tag memory into physically separated memory arrays with the entries of each array referencing cache lines in such a way that no two cache lines, which are consecutively aligned in data cache memory, reside in the same array. In another embodiment, the entries of the two memory arrays reference consecutively aligned cache lines in an alternating manner.

### CROSS REFERENCE TO RELATED APPLICATION

This application claims the benefit of U.S. Provisional Application No. 61/886,559, filed Oct. 3, 2013, which is incorporated by reference herein in its entirety.

### BACKGROUND

1. Field of Art

The present disclosure generally relates to the field of processor systems and related components used in such systems. In particular, the disclosure relates to cache memory systems implemented in a configurable processor core and the physical and virtual organization of these memory systems.

2. Description of the Related Art

Many processor or computer systems utilize cache memories to enhance compute performance. Cache memory is a memory type that is fast, limited in size, and generally located between a processor, e.g. the central processor unit (CPU), and memory located at other locations in the computer systems, e.g. the system memory. The speed of a processor in accessing data is significantly improved when the processor loads or stores data directly from the cache memory, referred to as a “hit,” instead from memory that has slower transfer rates (latency). In order to minimize access to the slower memory, the cache memory should cover at least ninety percent of all processor requests for data by duplicating data stored in the memory elsewhere in the system. In contrast, a “miss” requires the system to retrieve the data from the memory other than the cache.

Processes executing on a processor do not distinguish between accessing cache memory or other memory, where the operating system, e.g. the kernel, is handing the scheduling, load balancing and physical access to all the memory available on particular system architecture. To efficiently manage memory, programs are assigned memory based on a virtual not physical memory space, where the operating system maps virtual memory addresses used by the kernel and other programs to physical addresses of the entire memory. The virtual address space includes a range of virtual addresses available to the operating system that generally begin at an address having a lower numerical value and extend to the largest address allowed by the system architecture and is typically represented by a 32-bit address.

To effectively perform its purpose, cache memory uses two memory types. The first type, tag memory or tag RAM, determines the addresses of data that is actually stored in the second type, the data cache memory. In general, the tag memory contains as many entries as there are data blocks (cache lines) in the data cache memory. Each tag memory entry stores the most significant bits (MSB) of the memory address corresponding to the cache line that is actually stored in the data cache entry. Consequently, the least significant bits (LSB) of a virtual address represent an index that addresses a tag memory entry that stores the MSB of the memory's actual address.

A cache “hit” occurs when the MSB of the virtual address match the MSB stored in the tag memory entry that is indexed by the LSB of this virtual address. When a cache hit occurs, the requested data is loaded from the corresponding cache line in the data cache memory. A “miss” occurs when the tag memory entry will not match the MSB of the virtual address, indicating that the data is not stored in the data cache memory, but must instead be loaded from non-cache memory and stored into the data cache memory.

The time required to perform a cache refill that services a cache miss is significantly slower (e.g. loading data from external memory to store into the cache) than the processor speed and loading from the cache. Before loading data from non-cache memory a cache controller translates the memory's virtual address to its physical address and communicates the physical address to memory device containing the non-cache memory. The controller and memory device then communicate with each other over the system bus that is also utilized by other system devices. Consequently, the time in accessing data from non-cache memory significantly increases due to the system bus being a shared resource and the external memory being slower than the processor. Thus, in multi-processor systems, each processor is often equipped with its own cache memory that the processor accesses via a local bus while trying to minimize the access to the non-cache memory through the system bus.

One problem with cached memory includes “cache coherency” which arises for example when the same non-cache memory address is cached in two or more local caches. Upon storing new data in one local cache, the other caches still contain the old data until their data is also updated with the new data. Similarly, when a non-caching memory device writes data to memory which has been cached, the corresponding cache is outdated until it loads this data, too.

Data in external memory is generally arranged according to two different principles while data is stored in cache with the same layout as the external memory data. The first principle entails aligning the data along specified memory boundaries that are equal to multiples of the length of a system word. The system word is a natural unit of data, e.g. a fixed-sized number of bits that the system architecture treats as an undivided block. For example, most registers in a processor are equal in size to the system word and the largest data size that can be transferred in a single operation step along the system bus in most cases is a system word. Similarly, the largest possible address size for accessing memory is generally of the size of a system word.

Typically, modern general purpose computers utilize 32-bit or 64-bit sized system word, whereas other processors, including embedded systems, are known to use word sizes of 8, 16, 24, 32 or 64 bits. To align the data along memory boundaries superfluous bytes are inserted following the end of the last data unit and the subsequent boundary before adding the next data unit into memory. This approach is preferred among architectures that cannot handle unaligned memory access that results in an alignment fault exception caused by accessing a memory address that is not an integer multiple of the system word, e.g. a word to be loaded is unaligned if its memory address is not a multiple of 4 bytes in case of a 32-bit sized system word.

The alternative principle of data arrangement encompasses storing the memory in a compact form without requiring any data alignment in multiples of the system word length. This allows access to data across memory alignment boundaries. This compact approach does not waste any memory space by eliminating padding bits. Some architectures handle unaligned memory access through native hardware without generating alignment fault exceptions. However, the drawbacks of native hardware for handling unaligned access include increasing the number of compute cycles, and thus the system's latency, as compared to loading aligned words from memory. Typically, a computer system requires additional cycles for loading an unaligned word from cache, since the cache controller needs to serially process at least two virtual addresses, one of a data byte in the word prior and one past the cache line boundary, whereas processing of one address suffices for an aligned word.

In addition, known approaches of this principle suffer from a decreased predictability of the time that it takes to actually load the cache data, since the same load operation may take a variable number of cycles even when a cache hit occurs. Thus, besides an increase in cache memory area to load unaligned words these approaches often incorporate two cache read ports, two local address buses and two local data buses to reduce the cycle number. However, the duplicity of read ports and buses comes at the cost of significantly increased power consumption.

A need therefore exists for native hardware support to handle unaligned cache or general memory accesses that does not incur any cycle penalty, a larger cache memory area or increased power consumption.

### SUMMARY

Embodiments disclosed relate to a disclosed system, method and computer readable storage medium that relate to a computer system configured for efficient cache memory organization. Particular embodiments include dividing the tag memory into physically separated memory arrays with the entries of each array referencing cache lines in such a way that no two cache lines, which are consecutively aligned in data cache memory, reside in the same array. In one embodiment, the entries of the two memory arrays reference consecutively aligned cache lines in an alternating manner.

In one embodiment a computer system for efficient cache memory organization includes a data memory pipeline for receiving a memory address. In turn, the data memory pipeline unit that includes a data cache memory module comprising a plurality of cache lines, where each cache line configured to store a predetermined number of bytes of data. The data memory pipeline also includes a tag memory module configured to receive the memory address and communicate with the data cache memory module. The tag memory module includes a plurality of tags and two physically separated memory arrays, where each tag is indexed by an index value. The tags having an even index value are stored in the first memory array and the tags having an odd index value are stored in the second memory array. The memory address includes a parity bit indicative of the memory address referencing the first or the second memory array.

In one or more embodiments, the computer system includes a translation look-aside buffer that receives the memory address from the data management pipeline and translates the memory address into a physical memory address. Furthermore, in this embodiment of the configurable processor, each tag stored in the first and in the second memory array includes a physical memory address that can be matched against the physical memory address translated by the translation look-aside buffer.

One or more embodiments include the method for efficiently organizing cache memory. The method includes a step of providing a data memory pipeline for receiving a memory address. The provided data memory pipeline unit includes a data cache module that contains a plurality of cache lines. The method further includes storing a predetermined number of bytes of data in each cache line and providing a tag memory module that includes a plurality of tags and two physically separated memory arrays. The two memory arrays contain index values for each tag of the plurality of tags, thus indexing the plurality of tags. The method further includes storing the tags with an even index value in the first memory array and the tags with an odd index value in the second memory array. Furthermore, the method includes adding a parity bit in the memory address with the parity bit indicating whether the memory address references the first or the second memory array.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is high level block diagram depicting a computer system and cache memory utilizing even-indexed and odd-indexed tag memory, according to one embodiment.

FIG. 2 is a block diagram of an expanded view of a data memory pipeline system of three data cycles illustrating even-indexed and odd-indexed tag memory in combination with micro data and joint translation look-aside buffers, according to one embodiment.

FIG. 3A and FIG. 3B are block diagrams of loading an unaligned word from cache memory organized into even-indexed and odd-indexed tag memory, according to one embodiment.

FIG. 4 is a block diagram of loading an aligned word from cache memory organized into even-indexed and odd-indexed tag memory, according to one embodiment.

FIG. 5 is a block diagram illustrating components of a machine able to read instructions from a machine-readable medium and execute them in a processor, according to one embodiment.

### DETAILED DESCRIPTION OF EMBODIMENTS

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Embodiments of the present disclosure generally relate to a disclosed system, method and computer readable storage medium that relate to a computer system configured for efficient cache memory organization.

In one embodiment a configurable processor architecture for efficient cache memory organization includes a data memory pipeline for receiving a memory address. In turn, the data memory pipeline unit comprising: a data cache memory module comprising a plurality of cache lines, each cache line configured to store a predetermined number of bytes of data; a tag memory module configured to receive the memory address and communicate with the data cache memory module, the tag memory module comprising a plurality of tags and two physically separated memory arrays, each tag indexed by an index value, wherein the tags having an even index value are stored in the first memory array and the tags having an odd index value are stored in the second memory array; and the memory address comprising a parity bit indicative of the memory address referencing the first or the second memory array.

In one or more embodiments, the configurable processor architecture includes a translation look-aside buffer that receives the memory address from the data management pipeline and translates the memory address into a physical memory address. Furthermore, in this embodiment of the configurable processor architecture, each tag stored in the first and in the second memory array includes a physical memory address that can be matched against the physical memory address translated by the translation look-aside buffer.

Additional example embodiments disclosed herein relate to the method for efficiently organizing cache memory. The method includes a step of providing a data memory pipeline for receiving a memory address. The provided data memory pipeline unit includes a data cache module that contains a plurality of cache lines. The method further includes storing a predetermined number of bytes of data in each cache line and providing a tag memory module that includes a plurality of tags and two physically separated memory arrays. The two memory arrays contain index values for each tag of the plurality of tags, thus indexing the plurality of tags. The method further includes storing the tags with an even index value in the first memory array and the tags with an odd index value in the second memory array. Furthermore, the method includes adding a parity bit in the memory address with the parity bit indicating whether the memory address references the first or the second memory array.

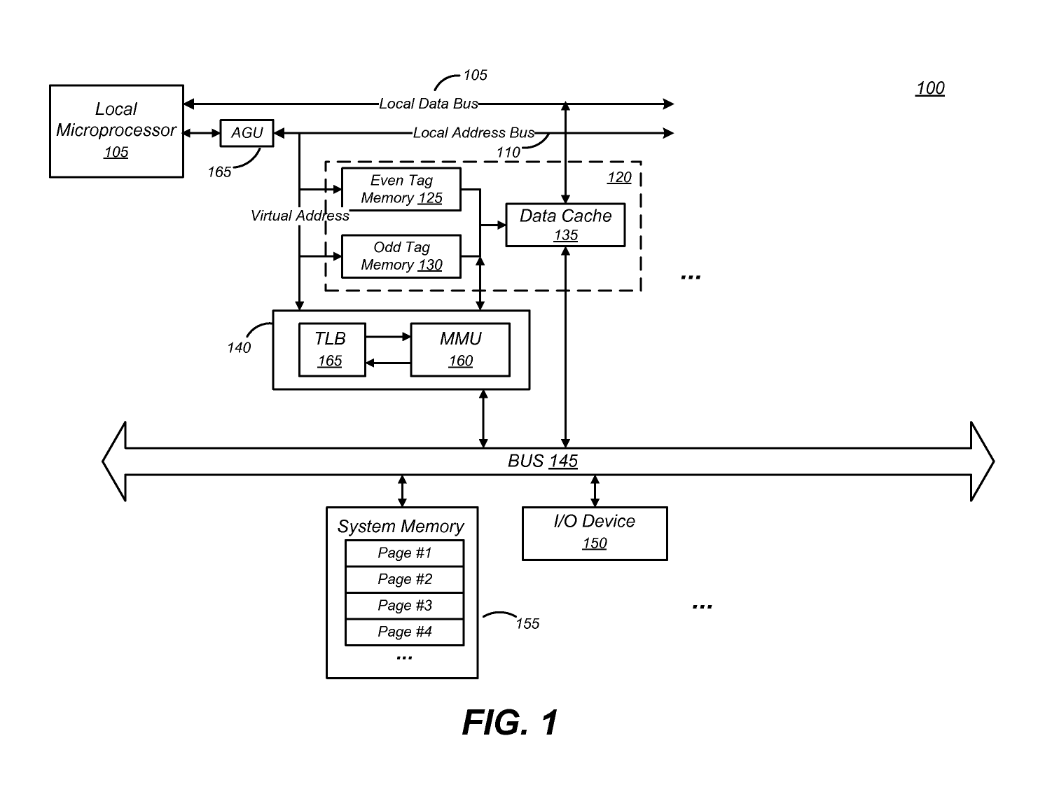

FIG. 1 is a high level block diagram illustrating a computer system 100 including a cache memory system, in accordance with an example embodiment. The computer system 100 includes a processor 105 that is connected to a local data bus 110 and a local address bus 115. The processor 105 generally includes a processing device to execute instructions (e.g., code or software). The processor 105 may be a specialized processor in that it is customizable to include memories, caches, arithmetic components, and extensions. The processor 105 may be programmed to operate as a reduced instruction set computing (RISC) processor, digital signal processor (DSP), graphics processor unit (GPU), applications processor (e.g., a mobile application processor), video processor, or a central processing unit (CPU) to access memory map, and exchange commands with other computing devices. In some embodiments, the processor 105 includes a pipeline. The pipeline includes multiple data processing stages connected in series. The processor 105 may be a single or multiple processor cores represented in an electronic format. In one example, the processor 105 is a configurable processor core represented in circuit description language, such as register transfer language (RTL) or hardware description language (HDL). In another example the processor 105 may be represented as a placed and routed design or design layout format (e.g., graphic data system II or GDS II). In a further example, the processor 105 may be configured to implement methods for reducing the overhead of translation look-aside buffers maintenance operations consistent with the methods described in this disclosure and embodied in silicon or otherwise converted into a physical device.

In an alternative embodiment, the local data bus 110 and local address bus 115 are combined to a single local bus that transmits both data and addresses to and from the processor 105 to other component of the computer system 100. The computer system 100 is further provided with local cache memory 120. The local cache memory 120 consists of even-indexed tag memory 125, odd-indexed tag memory 130, and data cache memory 135, each connected to the local processor 105 via the local address bus 110 and local data bus 115, respectively. The processor 105 also communicates with the cache controller 140 through the local address 110, which in turns is communicatively coupled to the system bus 145. In contrast to virtual address signals being transmitted along the local address bus 110, data and control signals from the processor 105 are transmitted along the local data bus 115 to the data cache memory 135, and finally to the system bus 145. In one embodiment (not shown), the system bus 140 is divided into a system address bus and a data system data bus with the former dedicated to transmitting address signals and the latter to data and control signals.

The system bus 145 also connects to a plurality of other input and/or output (IO) device 150 that allow the processor 105 access to IO data streams and network interface devices (not shown) that connect the computer system 100 to external networks (not shown). Other devices (not shown) that are communicatively coupled to the processors and components of computer system 100 via the system bus 145, include, but are not limited to, graphic displays, cursor control devices, storage unit modules, signal generating devices, alpha-numeric input devices, such as keyboards or touch-screens. Finally, the system bus 145 connects to the system memory 155. In one embodiment, the system memory 155 is partitioned into memory pages, each memory page containing a continuous block of memory of fixed length and being addressed through the page's physical address on the system memory 155. Since code or programs executed on the processor 105 generally utilizes addresses from the virtual address space, the cache controller needs to translate the virtual address into the physical page address if the computer system requires access to the corresponding memory page of the system memory 155.

The tag memory, in accordance with an example embodiment, is divided into even-indexed tag memory 125 and odd-indexed tag memory 130 so that the former only contains even-indexed addresses and the latter only address having odd indices. In turn, each tag memory 125 and 130 is connected to cache controller 140 and the data cache memory 135. The cache controller 140 contains the memory management unit (MMU) 160 and the translation look-aside buffer (TLB) 165 that translate a virtual memory address in the corresponding physical address of the system memory 155. In general, each tag memory 125 and 130 contains a plurality of entries corresponding to entries in data cache memory 135. Each entry is indexed by a number represented by the least significant bits of the virtual memory address transmitted along the local address bus. In one example embodiment, the local address bus is connected to an address generating unit (AGU) 165 that communicates with the processor 105 and generates the virtual address.

For unaligned cache memory accesses, i.e. by crossing cache line boundaries, both the even-indexed and odd-indexed tag memories are concurrently read despite accessing different indexes, thus eliminating any penalty for cache accesses that span over two cache lines. The entries of each tag memory contain the most significant bits of the physical memory address that is stored in the corresponding entry in data cache memory 135. Depending on the index in the virtual address generated by the AGU the entries of either the even-indexed and/or the odd-indexed tag memory are concurrently read.

When the least significant bits of the virtual address is an even index the address tag is compared to entries in the even-indexed tag memory, as to entries in the odd-indexed tag memory in case the index is odd. If the most significant bits stored in the tag memory entry that has the corresponding index match the most significant bits of the address generated by the AGU, a cache “hit” has occurred and the data is read from the corresponding entry in data cache memory 135. An unaligned cache memory access is considered a cache “hit” when each access to the even-indexed and odd-indexed tag memories constitutes a cache “hit,” respectively.

When data corresponding to a memory address is not stored in the data cache memory 135, the tag entry at that index will not match the most significant bits of that address, which is referred to as a cache “miss.” In case of a “miss” the data needs to be obtained from system memory and loaded into data cache memory 135. The cache controller then controls the data exchange between the data cache memory 135 with the local processor 105 and system memory 155. Generally, the tag memory can be divided into two types, depending on whether the tag corresponds to physical or virtual memory addresses. The tag memory of embodiment as shown in FIG. 1 contains physical memory addresses. However, embodiments of the present disclosure also include tag memory that contains virtual address tags. Similarly, example embodiments include virtually as well as physically indexes of tag memory. The advantage of virtually indexed and physically tagged cache memory is that the tag memory can be looked up in parallel with translating the virtual to the physical address, decreasing the latency of cache. However, the tag cannot be match unless the cache controller completes translating the address.

In referring to FIG. 1, the memory management unit (MMU) 160 and the translation look-aside buffer (TLB) 165 facilitate the data exchange between the processor 105, the cache, and the system memory by translating the virtual memory address into the corresponding physical address of the system memory 155. Typically, virtual memory requires the computer system 100 to translate virtual addresses generated by the operating system including the kernel into physical addresses on the system memory. The component of the computer system 100 that performs this translation is the MMU. A fast translation route through the MMU involves a table of translation mappings stored in the TLB 165, which is a cache of mappings from the operating system's page table that map virtual to physical addresses. The TLB 165 is used by cache controller to increase the translation speed, since it operates as a fast table-lookup operation. In one example embodiment, the computer system 100 contains one or more TLBs dedicated to different translation operations. In another embodiment, a TLB is exclusively utilized by the cache controller for paged virtual memory translations. In the example embodiment of FIG. 1, the TLB 165 includes content-addressable memory (CAM) that includes a CAM search key for the virtual address and a physical address entry for the search result. If the virtual address queried by the MMU is available in the TLB, the CAM search quickly returns the matched physical address entry of the TLB to be further used by the MMU. This is referred to as a “TLB hit.” In case of a “TLB miss,” meaning the queried address is not included the TLB cache entries, the MMU proceeds with the translation by performing a page walk through the page table. A page walk through involves loading at multiple locations the contents of the page memory and computing the physical address of the loaded content. After the page walk concludes by determining the corresponding physical address, the mapping of virtual to physical address is stored into the TLB cache. Thus, a page walk is a compute intensive process, adding significantly to the latency of accessing memory in the system architecture.

Upon a TLB hit the MMU passes the translated physical address back to either the even- or odd-indexed tag memory depending on the index in the virtual address's LSB for comparing the address with indexed tag entry in the tag memory. In case of a cache hit, the corresponding tag memory, 125 or 130, passes a signal to the data cache and the cache controller to indicate that the memory address generated by the AGU resides in the cache data memory. Subsequently the cache controller directly loads the data identified by the hit from the cache data memory and transmits the data along the local data bus to processor 105. However, in case of a cache miss, the cache controller retrieves the data from the system memory over the system bus utilizing the MMU and TLB as described above.

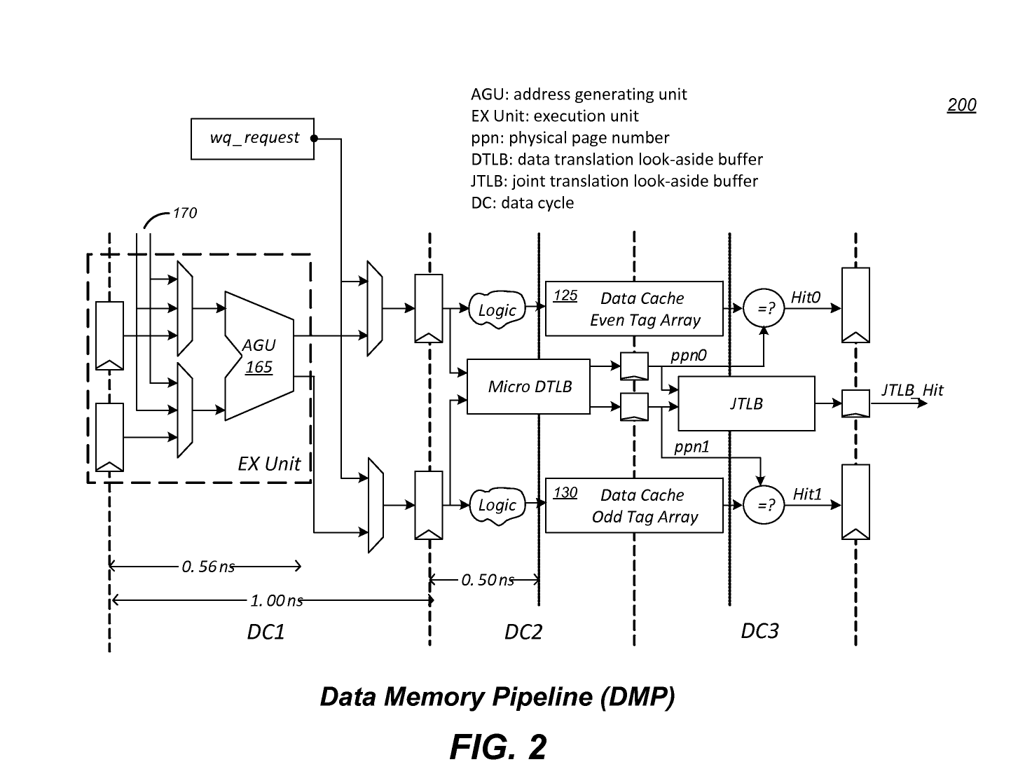

FIG. 2, a more detailed illustration of FIG. 1, is a block diagram of one of embodiment of an expanded view of a data memory pipeline system 200. The data memory pipeline covers three data cycles and includes even-indexed and odd-indexed tag memory, 125 and 130 utilized in combination with a micro data translation look-aside buffer (Micro DTLB) and joint translation look-aside buffer (JTLB). In this embodiment the data memory pipeline 200 operates on three data cycles, although in other embodiments the process described may be performed over a different number of cycles as may be required to satisfy different performance conditions. In one example embodiment each of the three data cycles last about 1 ns. In the first 0.56 ns of the first data cycle (DC) the processor 105 as part of the execution unit separately passes the entries of two registers representing a word-sized data unit requested by a program separately as inputs to two digital 3:1 multiplexers.

The Address Generation Unit (AGU) 165 is responsible for computing the effective memory address for a load or store instruction. For example on a reduced instruction set computing (RISC) machine, the computation of the memory address usually requires reading two registers, e.g. by executing the command “1d Rdest, [Rsrc0,Rsrc1]” the computed addresses Rsrc0 and Rsrc1 into the register Rdest. The memory address is formed by adding the content of the addresses Rsc0 and Rscr1 that are stored in the register Rdest. However, in example of a pipelined implementation the latest value of either Rsrc0 or Rsrc1 may not be in the register file. The missing values Rsrc0 or Rsrc1 are then forwarded from a pipeline stage downstream and stored in the register Rdest as indicted by the additional input lines 170 in FIG. 2 which reflect the AGU forwarding paths for the missing values.

The AGU provides two outputs, wherein the first output is the memory address of the first byte and the second output is the address of the last byte of the load or store instruction. The second output is necessary when the load or store instruction based on an unaligned load word. In this case the address parity bit of the AGU first output address differs from the parity bit of the second output address. For example, for a processor with 32-byte cache line and a load word starting at address 0x01F the AGU's first output (output0) is 0x01F, whereas its second output (output1) equals 0x022. Since this access crosses a cache line boundary with the first cache line at 0x00-0x1F and the second cache line at 0x020-0x03F, the first and second cache line are stored in the even-indexed and odd-indexed tag memory, respectively. Both tag memories are concurrently read for further processing without incurring any cycle penalty.

Each multiplexer in turn outputs the register entries to the address generating unit (AGU) that generates a bit representation of the virtual memory address based on the program-requested word. Although in this embodiment a 32-bit array represents the virtual address of each byte in the word, other embodiments can include bit arrays of different lengths representing the virtual address space, e.g. an array of 40 bits.

In one embodiment, during the first data cycle (DC1) the AGU may pass the 32-bit virtual address array to two separate digital 2:1 multiplexers, where one multiplexer is part of the even-indexed tag memory branch and the other multiplexer belongs to the odd-indexed tag memory branch. Both 2:1 multiplexers provide the general processing pipeline (not shown) with access to the cache to service cache misses without invoking the AGU. In case of cache misses new data stored in the data cache memory from the system memory. For the example of a copy-back cache, dirty lines need to be read-out form the data cache memory and sent to the system memory. Thus, both multiplexers provide interface to the cache memory as a shared resource within the processor core.

Utilizing an even-indexed and an odd-indexed tag memory branch in the data memory pipeline allows for parallel access and lookup of both tag memories and their caches lines This is particularly advantageous in case of any unaligned memory references across cache line boundaries, which would otherwise incur additional data cycles when stepping across a cache line boundary. The first data cycle completes with the multiplexer of each tag memory branch writing their respective output signals to separate registers.

In the first 0.5 ns of the second data cycle (DC2) the registers of each tag memory branch are accessed by separate logic modules that determine if the virtual address in the register contains an even or odd index based on the virtual address's LSB. The two logic modules are part of the AGU, indicating the two outputs described above. The two logic modules route the AGU outputs to the address of the even-indexed or odd-indexed tag memory depending on the parity bit of each output.

In the case of an even index, execution continues in the even-indexed tag memory branch with one of the logic modules retrieving the indexed entry from the even-indexed tag array, while the execution of the odd-indexed branch is stopped by the other logic module. On the other hand, if LSB contain an odd index, one logic module stops execution of the even-indexed tag memory branch. The other logic module continues execution in the odd-indexed tag memory branch. An alternative embodiment includes one or more logic modules with each module jointly or separately operating in either tag memory branch.

Synchronously, the register entries are passed to the Micro DTLB that translates the MSB of the virtual address to a physical memory address for comparison with the entry of the tag memory. Since the translation of the MSB and the de-indexing of the LSB by the logic module occur simultaneously, no additional data cycle is required. Even when accessing an unaligned word, i.e. crossing a page boundary between two TLB pages, no cycle penalty is incurred in the current embodiment as both addresses are translated into physical addresses (ppn0 and ppn1) and processed simultaneously. The translated physical addresses are stored at the end of the second DC in a temporary register that the cache controller accesses during the subsequent DC when comparing the tag memory entry to the actual address of the request data.

During the last data cycle (DC3) the retrieved entry from the tag memory array is compared to the physical page numbers stored in the temporary registers. In case of an even index, the cache controller compares the physical page number, ppn0, from the even-index branch register with the indexed entry retrieved from the even-indexed tag memory array. Similarly, if the index is odd, the cache controller performs the comparison of the physical page number, ppn1, from the odd-index branch register with the entry obtained from the odd-indexed tag memory array by the logic module.

If the virtual address is not found in the Micro DTLB its physical page number (ppn0 and/or ppn1) is passed to the JTLB to determine if the page number is already included in the JTLB's translation look-aside buffer, thus representing a “JTLB hit.” At the end of DC3 the result of the JTLB search is stored in a register. In case of cache hit in the even-index branch (Hit0) or in the odd-index branch (Hit1), the tag entries representing the physical page numbers are stored in the register of the respective branches. In subsequent cycles, the cache controller uses these register entries to load the corresponding data from the data cache memory, if the DMP returns a cache hit. If no cache hit occurs, the cache controller initiates a page walk, in case the DMP return no JTLB hit, too. No page walk is initiated when the DMP returns a JTLB hit, indicating that the page number is already included in the JTLB's translation look-aside buffer.

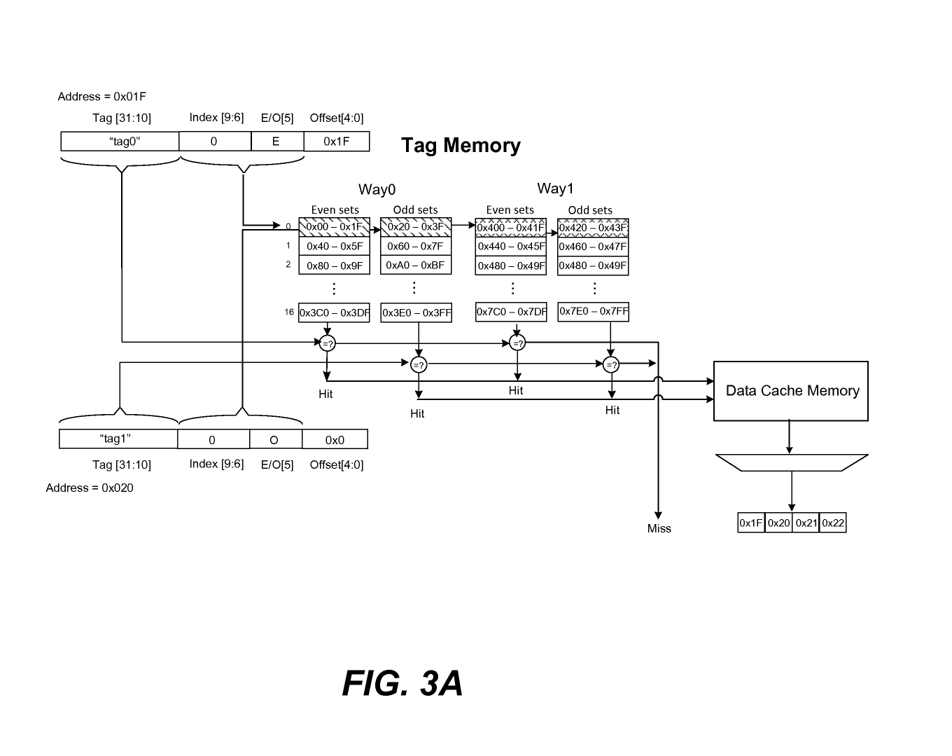

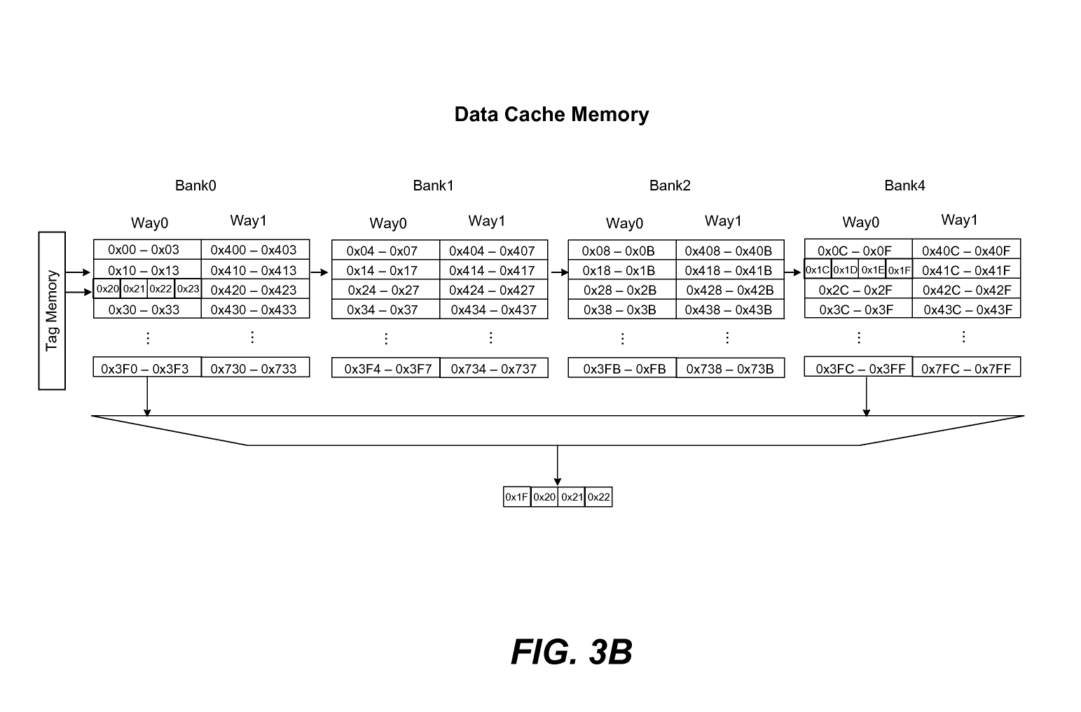

FIGS. 3A and 3B illustrate loading an unaligned word from cache memory organized into even-indexed and odd-indexed tag memory, according to an example embodiment. The tag memory cache is divided into even and odd sets contained in different physical locations within the cache memory, while maintaining the total capacity despite physical division of the cache memory. The number of indices per set is reduced by half when compared to a traditional cache design, while preserving the overall size of each tag. The advantage of this embodiment includes organizing the tag memory array such that neighboring data blocks (cache lines) reside in different physical cache locations. The figure illustrates the mapping of the cache lines into a more efficiently organized tag memory array.

In particular, the example in FIGS. 3A and 3B includes a 2-way parallel set associative cache with a size of 2 KB, each cache line containing 32 bytes, and a 32-bit address system architecture. In this example, the cache lines are organized into 4 different memory banks (bank0, bank1, bank2, and bank3) that are physically separated and therefore allow for concurrent access to each bank without any cycle penalty. The present disclosure, however, is not limited to any particular cache geometry or cache architecture so long it allows for concurrent access to memory that is separated by a cache line boundary. Other embodiments encompass cache architectures that include, but not limited to, way-predicted, serial, direct-mapped, fully associative, multi-way caches or any combination thereof and the like.

The data cache memory contains the data blocks (cache lines) of the actual data retrieved from other memory locations, e.g. the system memory, and stored in the cache. The number of cache lines is determined by the size of the cache, total amount of memory stored in the cache, divided by the number of bytes stored in each cache line. In the example shown in FIG. 3B there are 64 cache lines, since the size equals 2 KB with a line size of 32 bytes. Since the example cache is a 2-way set associate cache with storing data in four banks, each bank contains 8 bytes of the 64 cache lines, interleaving the two ways.

The bits of the 32-bit virtual memory address obtained from the AGU are split into 22 tag bits, four index bits, one parity bit, and five block offset bits from MSB to LSB. The block offset bits at positions [4:0] specify the starting location of a 4-byte word within a particular cache line, requiring five bits to address the 32 bytes of a cache line. The index bits at positions [9:6] determine the set number (index) of the particular cache line that stores the actual data. Since each way is divided into a set of even- and odd-indexed cache lines, equaling dividing the 32 cache line among the two sets, only four bits to index the 16 cache line in each set. The single parity bit at position [5] determines whether the tag containing the remaining 22 MSB of the 32-bit address and at positions [31:10] is contained in the even- or odd-indexed set of the tag memory. In alternative embodiments (not shown) the cache contains additional flag bits besides tag bits in the tag memory and the cache lines in the data cache memory. Although these flag bits, e.g. “valid” bits or “dirty” bits, do not directly influence the memory organization as disclosed herein, the overall size of the cache increases with an increasing number of flag bits.

The example of FIG. 3A illustrates loading an unaligned word from cache memory that is organized into even-indexed and odd-indexed tag memory, according to an example embodiment. The tag memory cache is divided into even- and odd-indexed sets contained in different physical locations within the cache memory, while the total cache capacity is not changed.

In this example a four-byte word is loaded from the cache referenced by addresses 0x01F to 0x022 in way0 (or equivalently 0x41F to 0x422 in way1), thereby crossing the cache line boundary between 0x01F and 0x020 in way0 (or 0x41F and 0x420 in way1). This unaligned cache memory access requires loading data from two cache lines, one with an even index of “0” referring to addresses 0x000 to 0x01F in way0 (or 0x400 to 0x41F in way1), and the other one with an odd index of “1” referring to addresses 0x020 to 0x03F in way0 (or 0x420 to 0x43F in way1). Thus, although the virtual addresses of the word's four bytes each contain the index bits “0x0,” the parity bit between the four differs with the first one being “even” and the others being “odd.” In addition, the offsets among the addresses of the four bytes are “0x1F,” “0x00,” “0x01,” and “0x02,” respectively.

Since the neighboring cache lines are stored in different physical locations of the tag memory, the data access and lookup of both cache lines can be processed in parallel resulting in no additional increase in number of cycle for any unaligned memory reference. In the shown example, the addresses of the first two bytes in the 4-byte word read the tag entries for the even-indexed set in way0 or way1 and the odd-indexed set in way0 or way1 based on their different parity bits, respectively.

The cache controller then retrieves the tag entries in the even sets with index “0,” namely “0x01F” and “0x41F,” and compares those entries with the tag bits, “tag0,” of the first byte's address to determine if the data is cached in either ways of the data cache. If one of the tag entries matches the address's tag bits, the controller reports a cache hit and loads the data from the corresponding cache line. Otherwise, the controller reports a cache miss and continues loading the data from non-cache memory as described above.

In parallel, the cache controller retrieves the tag entries in the odd sets with index “0,” namely “0x020” and “0x420,” and compares those entries with the tag bits, “tag1,” of the second byte's address to determine if the data is cached in either ways of the data cache. If one of the tag entries matches the address's tag bits, the controller reports a cache hit and loads the data from the corresponding cache line. Furthermore, the controller processes the addresses of the third and four byte in the word in parallel with the second byte, since their data is stored directly next to the data of the second word byte in the same cache line array. Thus, without crossing any cache line boundary the access to third and four byte's data does not require any additional cycles. The parallel access to the two physically distinct memory locations of the even- and odd-indexed sets of tag memory eliminates the need for dual load and/or store ports for the tag memory.

In the shown example the controller reports one hit among the even-indexed tag entries and one hit among the odd-indexed tag entries referencing addresses “0x01F” to “0x022” in data cache memory, respectively. Hits and misses are reported based on cache line granularity. Here, only two hits are reported, since the start address of 0x01F belongs to the cache line spanning the addresses from 0x000 to 0x01F, and the end address of 0x022 belongs to the cache line of addresses from 0x020 to 0x03F. Subsequently the controller loads the data from these addresses in the cache into the register at the end of DC3 as described in more detail under FIG. 2.

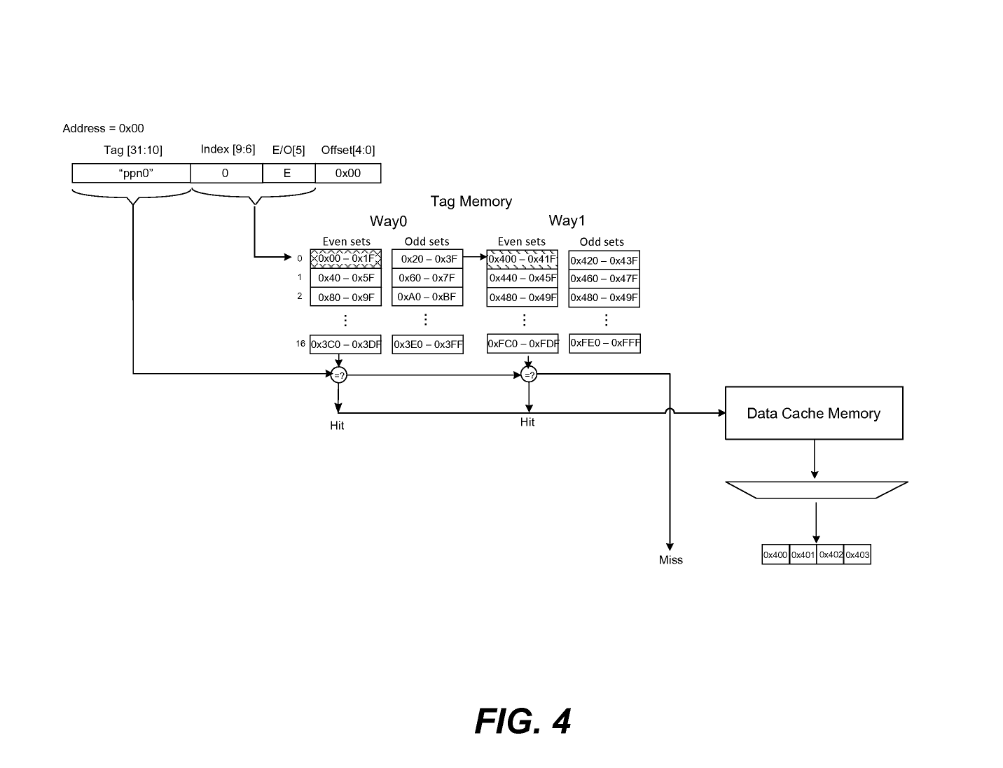

In comparison, FIG. 4 illustrates the virtual memory address for loading an aligned word from the cache which includes determining whether the even- or odd-indexed tag memory should be accessed. This example as the example in FIGS. 3A and 3B includes a 2-way parallel set associative cache with a size of 2 KB, each cache line containing 32 bytes, and a 32-bit address system architecture with the present disclosure not limited to this particular cache configuration.

In the shown example a processor requests loading of a 4-byte word that is aligned with the 0x000 (or equivalently the “0x400) address of the cache memory. This access represents a “purely” even access without crossing any cache line boundaries, since all four addresses, 0x000 to 0x004 (or equivalently 0x400 to 0x404), of the request 4-byte word reside within the even sets of the tag memory array.

The virtual address of the word's first byte, 0x000, thus contains the index bits “0x0” and “even” parity bit to represent the tag memory entry of index “0” within the even sets of either way 0 or way 1. The offset bits equal “0x0,” since the address is aligned with the starting byte of tag memory entry in both even sets. Thus, no offset is required to load the data from the data cache memory, which those two even set tags refer to. The cache controller therefore retrieves the tag entries in the even sets with index “0,” namely “0x000” and “0x400,” and compares those entries with the address's tag bits, “ppn0,” to determine if the data is cached in either ways of the data cache. If one of the tag entries matches the address's tag bits, the controller reports a cache hit and loads the data from the corresponding cache line. Otherwise, the controller reports a cache miss and continues loading the data from non-cache memory as described above.

In the shown example the controller reports four hits among the even-indexed tag entries referencing addresses “0x400” to “0x404” in data cache memory, and subsequently loads the data from these addresses in the cache into the register at the end of DC3 as described in more detail under FIG. 2.

Overall, only three data cycles are required in the embodiments shown in FIGS. 2-4 for loading an aligned or unaligned word from data cache memory with two cycles for determining cache hits and obtaining the physical tag address. Using only three cycles helps save energy and thus reduce the power consumption of the processor as well as the number of entries looked up prior to accessing the data from data cache memory.

In addition, no memory penalty is introduced with organizing the cache memory into even-indexed and odd-indexed tag sets, since the sum of both sets still equals the total tag memory required for a non-divided tag set. Another advantage includes the ability of parallel access of both tag sets because of holding the sets in physically separated memory location eliminates any need for dual ports of loading and storing data to the tag memory or data memory cache.

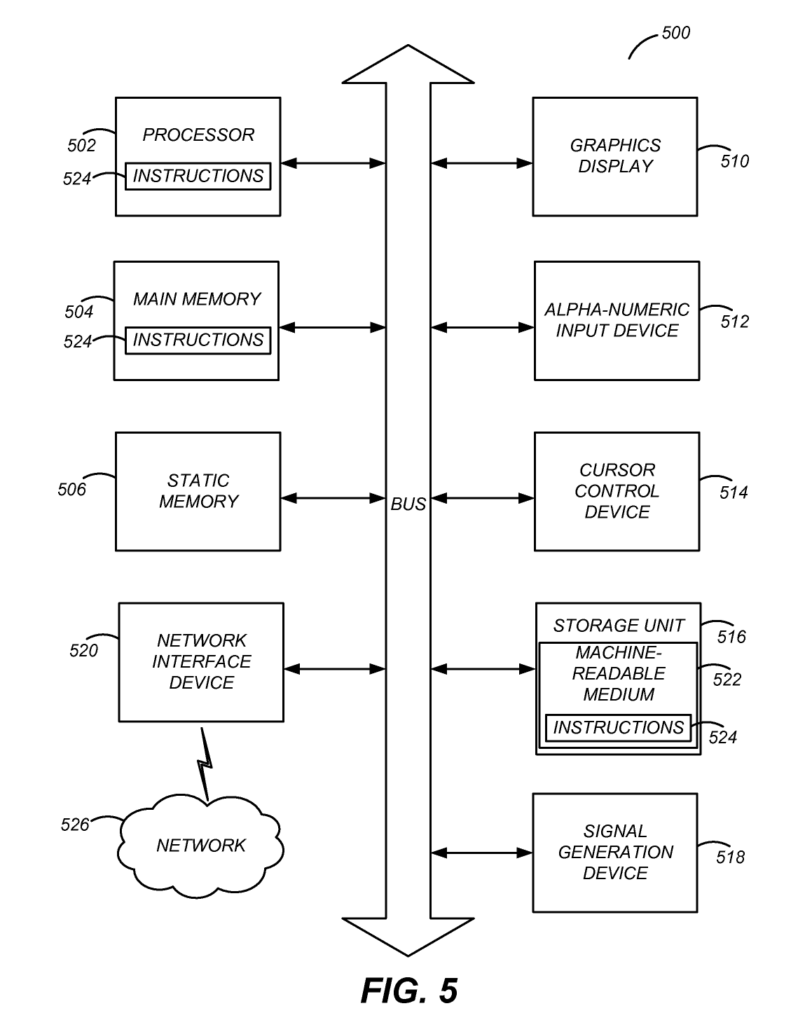

FIG. 5 is a block diagram illustrating components of an example machine able to read instructions from a machine-readable medium and execute them in a processor (or controller). Specifically, FIG. 5 shows a diagrammatic representation of a machine in the example form of a computer system 500 within which instructions 524 (e.g., software) for causing the machine to perform any one or more of the methodologies discussed herein may be executed. The computer system 500 may be used to perform operations associated with designing a test circuit including a plurality of test core circuits arranged in a hierarchical manner.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include graphics display unit 510 (e.g., a plasma display panel (PDP), a liquid crystal display (LCD), a projector, or a cathode ray tube (CRT)). The computer system 500 may also include alphanumeric input device 512 (e.g., a keyboard), a cursor control device 514 (e.g., a mouse, a trackball, a joystick, a motion sensor, or other pointing instrument), a storage unit 516, a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network 526 via the network interface device 520. The machine-readable medium 522 may also store a digital representation of a design of a test circuit.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

In addition, use of the “a” or “an” are employed to describe elements and components of the embodiments herein. This is done merely for convenience and to give a general sense of the embodiments. This description should be read to include one or at least one and the singular also includes the plural unless it is obvious that it is meant otherwise.

While particular embodiments and applications have been illustrated and described, it is to be understood that the embodiments are not limited to the precise construction and components disclosed herein and that various modifications, changes and variations may be made in the arrangement, operation and details of the method and apparatus disclosed herein without departing from the spirit and scope of this disclosure.

What is claimed is:

1. A computer system for efficient cache memory organization, the computer system comprising:
a data memory pipeline for receiving a memory address, the data memory pipeline unit comprising:
a data cache memory module comprising a plurality of cache lines, each cache line configured to store a predetermined number of bytes of data;
a tag memory module configured to receive the memory address and communicate with the data cache memory module, the tag memory module comprising a plurality of tags and two physically separated memory arrays, each tag indexed by an index value, wherein the tags having an even index value are stored in the first memory array and the tags having an odd index value are stored in the second memory array; and
the memory address comprising a parity bit indicative of the memory address referencing the first or the second memory array.

2. The computer system of claim 1, wherein the memory address further comprises a tag and an index value, the index value referencing a first tag entry in the first memory array having the identical index value and a second tag entry in the second memory array having the identical index value.

3. The computer system of claim 2, wherein the tag of the memory address is configured to be separately compared to the first entry in the first memory array and to the second tag entry in the second memory array.

4. The computer system of claim 3, wherein the data cache memory is configured to return the data stored in the cache line referenced to by the first tag entry upon obtaining a match between the first tag entry and the tag of the memory address or to return the data stored in the cache line referenced to by the second tag entry upon obtaining a match between the second tag entry and the tag of the memory address.

5. The computer system of claim 1 further comprising:
a translation look-aside buffer configured to receive the memory address, wherein the translation look-aside buffer translates the memory address into a physical memory address.

6. The computer system of claim 5, wherein each tag stored in the first memory array and in the second memory array comprises a physical memory address that is adopted to be matched against the physical memory address translated by the translation look-aside buffer.

7. The computer system of claim 6, wherein the memory address further comprises an index value, the index value referencing a first tag entry in the first memory array and a second tag entry in the second memory array, both tag entries having the identical index value, and the data memory pipeline is further configured to translate of the memory address by the translation look-aside buffer in parallel with looking up the first and second tag entries.

8. A computer implemented method for efficiently organizing cache memory, the method comprising:
providing a data memory pipeline for receiving a memory address, the data memory pipeline unit comprising:
a data cache module comprising a plurality of cache lines;
storing a predetermined number of bytes of data in each cache line;
providing a tag memory module comprising a plurality of tags and two physically separated memory arrays
indexing each tag of the plurality of tags by an index value;
storing the tags having an even index stored in the first memory array and the tags having an odd index value in the second memory array; and
adding a parity bit in the memory address, the parity bit being indicative of the memory address referencing the first or the second memory array.

9. The computer implemented method of claim 8, wherein the memory address further comprises a tag and an index value, the index value referencing a first tag entry in the first memory array having the identical index value and a second tag entry in the second memory array having the identical index value.

10. The computer implemented method of claim 9 further comprising:
separately comparing the tag of the memory address to the first entry in the first memory array and to the second tag entry in the second memory array.

11. The computer implemented method of claim 10 further comprising:
returning the data stored in the cache line referenced to by the first tag entry upon obtaining a match between the first tag entry and the tag of the memory address or the data stored in the cache line referenced to by the second tag entry upon obtaining a match between the second tag entry and the tag of the memory address.

12. The computer implemented method of claim 1 further comprising:
providing a translation look-aside buffer configured to receive the memory address, wherein the translation look-aside buffer translates the memory address into a physical memory address.

13. The computer implemented method of claim 12, wherein each tag stored in the first memory array and in the second memory array comprises a physical memory address that is adopted to be matched against the physical memory address translated by the translation look-aside buffer.

14. The computer implemented method of claim 13 further comprising:
translating the memory address by the translation look-aside buffer in parallel with looking up a first and a second tag entry,
wherein the memory address further comprises an index value, the index value referencing the first tag entry in the first memory array and the second tag entry in the second memory array, both tag entries having the identical index value.

15. A computer program product comprising a non-transitory computer-readable storage medium containing instructions for:
providing a data memory pipeline for receiving a memory address, the data memory pipeline unit comprising:
a data cache module comprising a plurality of cache lines;
storing a predetermined number of bytes of data in each cache line;
providing a tag memory module comprising a plurality of tags and two physically separated memory arrays
indexing each tag of the plurality of tags by an index value;
storing the tags having an even index stored in the first memory array and the tags having an odd index value in the second memory array; and
adding a parity bit in the memory address, the parity bit being indicative of the memory address referencing the first or the second memory array.
